(19) United States
(12) Patent Application Publication
(10) Pub. No.: US 2017/0106803 A1
(43) Pub. Date: Apr. 20, 2017

(54) AUTOMOBILE FLOOR MAT

(71) Applicant: Yoshimitsu Carpet Co., Ltd., Osaka (JP)

(72) Inventors: Kenji YOSHIDA, Osaka (JP); Masaru HASHIMOTO, Osaka (JP)

(21) Appl. No.: 15/189,358

(22) Filed: Jun. 22, 2016

(30) Foreign Application Priority Data
Oct. 16, 2015 (JP) 2015-005249

(51) Int. Cl. B60R 7/04; B60R 7/08

(52) U.S. Cl. CPC B60R 7/043; B60R 7/08

(57) ABSTRACT

An automobile floor mat with increased added value is provided by making an insect repellent member, an odorizing member, or a deodorizing member continuously replaceable. The automobile floor mat includes a mat body that is laid on a floor of an automobile and a storage portion that is fixedly attached to the mat body and stores at least one member selected from the group consisting of an insect repellent member, a deodorizing member, and an odorizing member.

### BACKGROUND OF THE DEVICE

(1) Field of the Device

This device relates to an automobile floor mat.

(2) Description of the Related Art

Conventionally, automobile floor mats are preinstalled in automobiles as basic equipment.

The automobile floor mats are known for having an antimicrobial function imparted by applying insect repellent treatment to the surfaces or the fiber itself of the mats. For example, Japanese Unexamined Utility Model Application Publication No. Hei 61(1986)-105241 (PTL 1) discloses an automobile floor mat whose raised yarn tufts are made of yarns kneaded with an insect repellent agent in advance to prevent bacteria, mites, and so on from occurring or growing.

In addition, deodorizers and fragrances for automobiles are also known. The deodorizers for automobiles, and so on, are mostly not basic equipment in the automobiles, but they are attached by drivers to any places the drivers choose, for example, in the vicinity of an air conditioning vent.

### SUMMARY OF THE DEVICE

The automobile floor mat disclosed in PTL 1 loses its insect repellent effectiveness over a certain period of time, and therefore the whole floor mat needs to be replaced to keep the insect repellent effect.

The deodorizer, or the like, also loses its effectiveness over a certain period of time, and there is no place in an automobile specifically designed to attach the deodorizer. Even after the effective period of the deodorizer expires, many drivers do not buy a new deodorizer.

The present device has been made to solve the aforementioned problems and has an object to provide an automobile floor mat with increased added value by making an insect repellent member, an odorizing member, or a deodorizing member continuously replaceable.

For this object, the automobile floor mat according to an embodiment of the device includes a mat body that is laid on a floor of an automobile, and a storage portion that is fixedly attached to the mat body and stores at least one member selected from the group consisting of an insect repellent member, a deodorizing member, and an odorizing member.

Preferably, the storage portion is in the form of a bag.

Preferably, the storage portion is made of a breathable material.

Preferably, the storage portion has an upper edge fixedly attached to the mat body and a lower edge extending outward from a rear edge of the mat body.

Preferably, the automobile floor mat is a floor mat for a front passenger's seat area.

Preferably, the automobile floor mat is a floor mat for a rear passenger's seat area.

Preferably, the rear passenger's seat area is positioned diagonally backward with respect to the front passenger's seat area.

The device can provide an automobile floor mat with increased added value by making an insect repellent member, an odorizing member, or a deodorizing member continuously replaceable.

### BRIEF DESCRIPTION OF THE DRAWINGS

FIG. 1 is a front view of an automobile floor mat according to an embodiment of the present device;

FIG. 2 is a front view showing a part in FIG. 1 on an enlarged scale;

FIG. 3 is a cross-sectional view of a storage portion taken along a line III-III in FIG. 2;

FIG. 4 is a schematic side view of an automobile in which the automobile floor mat is laid; and

FIG. 5 is a schematic plan view of areas where the automobile floor mat is laid in the automobile.

### DETAILED DESCRIPTION OF THE PREFERRED EMBODIMENT

With reference to the drawings, an embodiment of the present device will be described in detail. The same or similar components are denoted by the same reference symbols or reference numerals throughout the drawings, and the description thereof will not be reiterated.

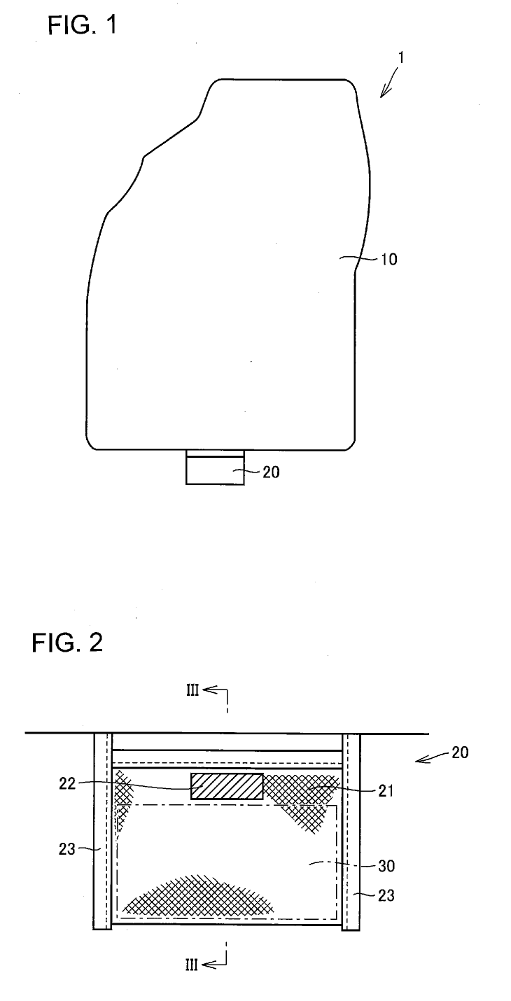

Referring now to FIG. 1, an automobile floor mat 1 according to an embodiment will be described.

The automobile floor mat 1 includes a mat body 10 that is laid on a floor in an automobile, and a storage portion 20 that is fixedly attached to the mat body 10. The storage portion 20 is provided to store an insect repellent member 30, which will be described later.

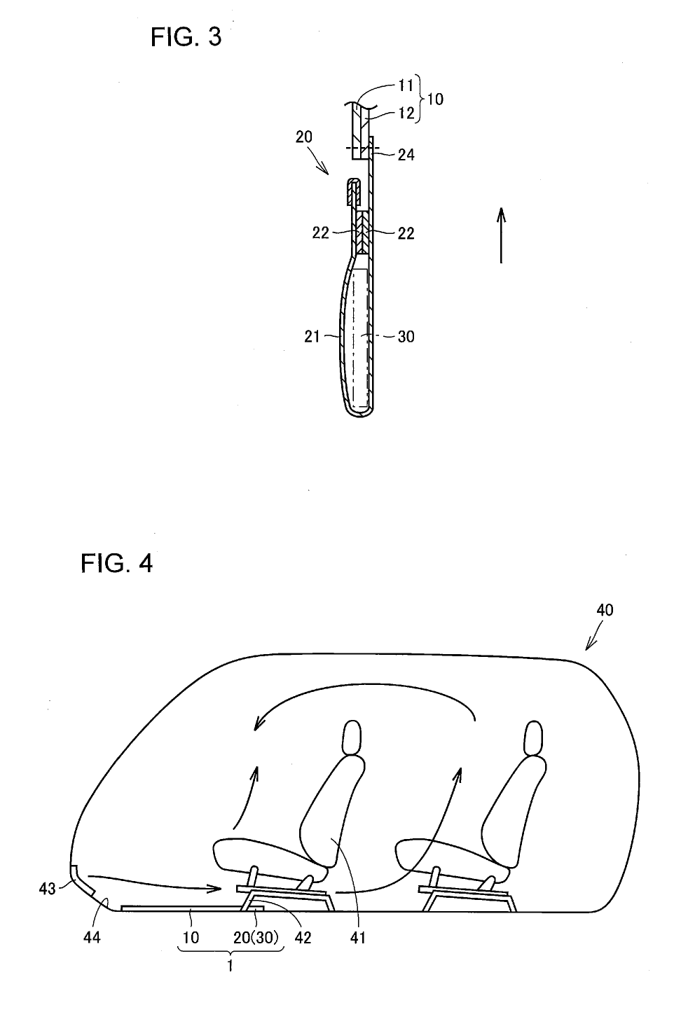

Firstly, a description will be made about the mat body 10 and the storage portion 20. FIG. 2 is a front view of the storage portion 20 in FIG. 1 on an enlarged scale, and FIG. 3 is a cross-sectional view of the storage portion 20 taken along a line III-III in FIG. 2. In FIG. 3, the arrow's tip points upward, while the arrow's tail points downward.

Referring to especially FIG. 3, the mat body 10 includes a surface layer 11 that is a carpet, and a backing layer 12 that is provided on a back face of the surface layer 11. The mat body 10 can be made of only the surface layer 11. As will be described later, an interior carpet 44 (FIG. 4) is laid on a floor of the automobile. Since the mat body 10 is laid on the interior carpet 44 (in most cases, a carpet with napped pile yarns) for use, it is preferable for the mat body 10 to have anti-slip effect. Thus, the mat body 10 is preferably provided with the backing layer 12 having the anti-slip effect.

Referring to FIGS. 2 and 3, the storage portion 20 takes the shape of a bag to store the insect repellent member 30 indicated by a dot-and-dash line. The storage portion 20 includes a bag 21 and a pair of touch-and-close fasteners 22 used to close the opening of the bag 21. The size of the bag 21 is set to be big enough to store the insect repellent member 30, and is made by folding a piece of rectangular fabric as viewed in plan and hemming both side edges 23 on the right and left sides. The touch-and-close fasteners 22 of the pair are attached to interior faces of the bag 21, separately. This configuration can facilitate replacement of the insect repellent member 30, while preventing the insect repellent member 30 from easily coming out of the bag 21.

The bag 21 is made of a breathable material, and more particularly is made of a mesh fabric. In addition, the bag 21 is made of a material capable of resisting cleaning along with the mat body 10, for example, synthetic fiber fabric such as nylon.

The storage portion 20 has an upper edge 24 that is fixedly attached to the mat body 10. Specifically, the upper edge 24 of the bag 21 is sewn to an outer edge of the backing layer 12 of the mat body 10. Therefore, the bag 21 projects from a lower end of the mat body 10 at nearly the center in the width direction of the mat body 10. In other words, the storage portion 20 is disposed on the outside of the mat body 10 without being overlaid. This configuration allows wind to hit the insect repellent member 30 efficiently even when it is stored in the bag 21, and therefore does not inhibit the effectiveness of the insect repellent agent by blocking the spread thereof.

The insect repellent member 30 is made of a plate material, which is rectangular as viewed in plan, kneaded with ingredients of an insect repellent agent. The insect repellent agent is formulated for flying insects, such as flies and mosquitoes, and is harmless to mammals. The insect repellent agent volatilizes with wind hitting thereon to keep the flying insects, such as flies and mosquitoes, away from the automobiles. The effective period of the insect repellent agent is, for example, from thirty days to one year. Because the insect repellent member 30 has a limited effective period, the storage portion 20 can be provided on its front face with a label where a user can fill in the date of the effective period.

The insect repellent member 30, which has an effective period as described above, needs to be replaced periodically according to the effective period. The automobile floor mat 1 according to the embodiment makes it possible to replace the insect repellent member 30 with a new one at the time of periodic automobile checkups by the automobile dealer, or at other periodic intervals. This can add a continual value, which is periodic replacement of the insect repellent member 30, to the automobile floor mat 1, thereby increasing added value of the automobile floor mat 1.

Incidentally, the storage portion 20 can store not only the insect repellent member 30, but also a deodorizing member or an odorizing member. As in the case of the insect repellent member, the deodorizing member and odorizing member also have their own effective period, and thus can impart an equivalent added value to the automobile floor mat 1.

Next, a description will be made about how the automobile floor mat 1 is laid. FIG. 4 is a schematic diagram of an automobile in which the automobile floor mat 1 is laid.

Referring to FIG. 4, the automobile floor mat 1 is laid so that the storage portion 20 is disposed below a seat 41 of an automobile 40. In other words, the storage portion 20 is disposed between seat legs 42 which support the seat 41 from below. The storage portion 20 disposed as above avoids contact with a passenger's feet, and does not become an obstacle. In addition, wind from an air conditioning vent 43 provided in a footwell hits the insect repellent member 30 to volatilize the insect repellent agent, thereby effectively filling the automobile 40 with the insect repellent agent. Thus, flies and mosquitoes can be prevented from entering the automobile 40.

If the seat 41 is the type of a seat supported by a seat base and has no space under the seat 41, the storage portion 20 leans against the seat base in an almost upright posture. Even in this case, the storage portion 20 avoids contact with a passenger's feet without becoming an obstacle, and also wind from the air conditioning vent 43 hits the insect repellent member 30, thereby providing effectiveness of the insect repellent agent.

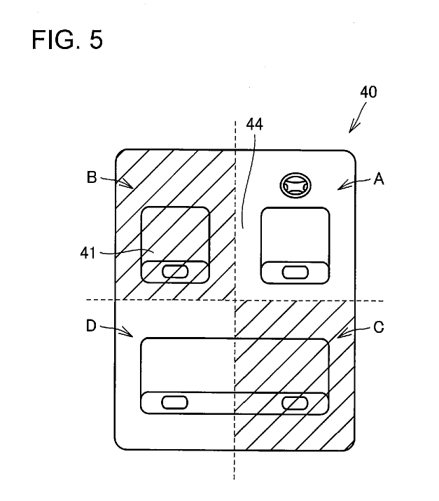

A description will be made about areas where the automobile floor mat 1 is laid in the automobile 40. FIG. 5 is a schematic plan view of the areas where the automobile floor mat 1 is laid in the automobile 40.

Referring to FIG. 5, an interior carpet 44 in an automobile 40 is an interior carpet designed for automobiles and laid on the entire floor of the automobile 40. Specifically, the interior carpet 44 is laid on the entire floor including a driver's seat area A, a front passenger's seat area B, a rear passenger's seat area C behind the driver's seat area A, and a rear passenger's seat area D behind the front passenger's seat area B, and the interior carpet 44 includes pile yarns napped on a front surface. On the interior carpet 44 laid is the automobile floor mat 1 under and around the feet of the driver or passenger.

Preferably, the automobile floor mat 1 is a floor mat for the front passenger's seat area B. This is because in the vicinity of the front passenger's seat area B there is the air conditioning vent 43, but not an accelerator nor other pedals. Such an environment does not require rigorous safety standards. The storage portion 20 that is designed to be disposed below the seat 41 is not obstructive in any areas A to D; however, the driver's seat area A needs to meet high safety standards, and therefore it is not preferable to lay the automobile floor mat 1 in the driver's seat area A.

The automobile floor mat 1 can be laid in the rear passenger's seat areas C or D instead of the front passenger's seat area B. In this case, the mat body 10 is laid across the rear passenger's seat areas C and D, and the storage portion 20 can be disposed in either one of the rear passenger's seat areas C and D, or between the rear passenger's seat areas C and D.

As shown by hatch patterns in FIG. 5, the automobile floor mat 1 can be laid on a diagonal line in the automobile 40. Specifically, in addition to an automobile floor mat 1 laid in the front passenger's seat area B, another automobile floor mat 1 can be laid in the rear passenger's seat area C diagonally backward with respect to the front passenger's seat area B. The automobile floor mats 1 disposed as above can spread the effectiveness of the insect repellent agent into nooks and corners of the automobile 40, even if the automobile 40 is a large car such as a van.

Although the storage portion 20 is in the form of a bag in this embodiment, the storage portion 20 may be a slit formed in the surface layer 11 of the mat body 10.

In addition, the storage portion 20 in this embodiment is made of a mesh material; however, this device is not limited thereto. The storage portion 20 can work as long as it allows air to pass through, and therefore, for example, the storage portion 20 may have a bag 21 made of an air-impervious material with a plurality of openings.

Although the embodiment of the present device has been described with reference to the figures, the present device is not limited to the illustrated embodiment. Various modifications and variations can be made to the above illustrated embodiment within the same scope as, or an equivalent scope to, the present device.

1. An automobile floor mat comprising:
a mat body configured to be laid on a floor of an automobile; and
a storage portion attached to the mat body, the storage portion being configured to store one or more of an insect repellent member, a deodorizing member, or an odorizing member.

2. The automobile floor mat according to claim 1, wherein the storage portion is a bag.

3. The automobile floor mat according to claim 1, wherein the storage portion comprises a breathable material.

4. The automobile floor mat according to claim 1, wherein the storage portion comprises an upper edge attached to the mat body and a lower edge extending outward from a rear edge of the mat body.

5. The automobile floor mat according to claim 1, wherein the automobile floor mat is configured to be placed in a front passenger seat area of an automobile.

6. The automobile floor mat according to claim 1, wherein the automobile floor mat is configured to be placed in a rear passenger seat area of an automobile.

7. The automobile floor mat according to claim 6, wherein the rear passenger seat area within which the automobile floor mat is configured to be placed is positioned diagonally backward with respect to the front passenger seat area.

8. The automobile floor mat according to claim 1, wherein the storage portion is fixedly attached to the mat body.
